(19) United States
(12) Patent Application Publication
(10) Pub. No.: US 2010/0037464 A1
(43) Pub. Date: Feb. 18, 2010

(54) Packaging Scissors

(76) Inventor: Rodney Underhill, Plano, TX (US)

Correspondence Address: Alan Lintel, #360, 3824 Cedar Springs Rd., Dallas, TX, 75219, US

(21) Appl. No.: 12/582,739

(22) Filed: Oct. 21, 2009

Related U.S. Application Data
(63) Continuation-in-part of application No. 11/461,264, filed on Jul. 31, 2006.

(51) Int. Cl. B25F 1/00; B26B 13/00; B26B 11/00

(52) U.S. Cl. 30/146; 30/233

(57) ABSTRACT

Scissors for cutting thermoformed plastic packages, or similar packages, have lever members including a handle portion, a offset portion and a cutting portion. The cutting portion includes cooperating blades of approximately 2.5 inches, with one of the blades having a pointed tip for piercing the packaging material. The offset portion keeps the user's hand at least 1.5 to 2 inches above a cutting plane, such that the cut material, which has sharp edges, does not scratch or cut the user's hand.

### CROSS-REFERENCE TO RELATED APPLICATIONS

This application is a continuation-in-part of U.S. Ser. No. 11/461,284, entitled “Packaging Scissors”, filed Jul. 31, 2006, to Underhill, which is incorporated by reference herein.

### STATEMENT OF FEDERALLY SPONSORED RESEARCH OR DEVELOPMENT

Not applicable.

### BACKGROUND OF THE INVENTION

1. Technical Field

This invention relates in general to cutting apparatus and, more particularly, to scissors for cutting plastic packaging.

2. Description of the Related Art

Thermoformed plastic packaging has become increasingly popular with product manufacturers and merchants. First, it clearly shows the product while on display. Second, it can be formed to the product to reduce materials and space. Third, it is extremely cost effective. Fourth, the edges can be sealed to make virtually tamper proof; it is almost impossible for someone to remove items from a secure thermoplastic package.

Unfortunately, the security provided by a secure thermoplastic package makes it extremely difficult for an honest consumer to open the package after purchase. Pulling apart the plastic pieces forming the shell is practically impossible. Cutting the package with scissors is difficult and the sharp edges of the package can scrape the purchaser's hands as the plastic is being cut. Cutting the package with a utility knife or other blade is extremely dangerous because the plastic does not cut cleanly and the blade can easily slip away from the plastic.

Therefore, a need has arisen for an apparatus for cutting plastic packaging.

### BRIEF SUMMARY OF THE INVENTION

In the present invention, scissors are provided for cutting through packaging comprising first and second lever members and a coupling member about which the levers may rotate. The lever members each include a cutting portion, a handle portion and an offset portion, with the offset portion disposed at an angle between the cutting portion and handle portion. The offset portion keeps the user's hand at least 1.5 inches from a cutting plane defined by the cutting portions. A lower handle portion includes a guard member extending outwardly from the handle to protect a user's hands from a cut edge of the packaging as the packaging is being cut.

The present invention provides a significant advantage—even if the packaging has multiple levels that would cause a cut edge to be far enough above the cutting plane to contact the users hand, the user's fingers are protected during cutting.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates a front view of a preferred embodiment of the package cutting scissors (or “shears”) of the present invention;

FIG. 2a illustrates a top view of a cutting portion showing a pointed tip for piercing the packaging material; and

FIG. 2b illustrates a side view of a cutting portion showing a pointed tip for piercing the packaging material;

FIG. 2c illustrates a front view of a cutting portion showing a pointed tip for piercing the packaging material;

FIG. 3a illustrates a top view of a cutting portion showing a second embodiment for a pointed tip for piercing the packaging material;

FIG. 3b illustrates a side view of a cutting portion showing a second embodiment for a pointed tip for piercing the packaging material;

FIG. 3c illustrates a front view of a cutting portion showing a second embodiment of a pointed tip for piercing the packaging material;

FIGS. 4a and 4b illustrate side and top views, respectively, of a finger shield disposed on the lower handle of the scissors to shield the user's finger's during cutting;

FIGS. 5a and 5b illustrate side and back views of an open ended lower handle portion for facilitating gripping of the lower handle using the shield of FIGS. 4a-b;

FIGS. 6a and 6b illustrate side and top views, respectively, of a divider disposed on the front of the lower handle of the scissors to divide the cut edges of the packaging material and force the edges downward below the user's fingers during cutting;

FIG. 7a illustrates a side view of a handle with a sleeve disposed on the lower handle for encompassing the user's hand during cutting; and

FIGS. 7b and 7c illustrate back views of the handle of FIG. 7a showing the sleeve in a position to receive the user's fingers and a position to grip the handle, respectively.

### DETAILED DESCRIPTION OF THE INVENTION

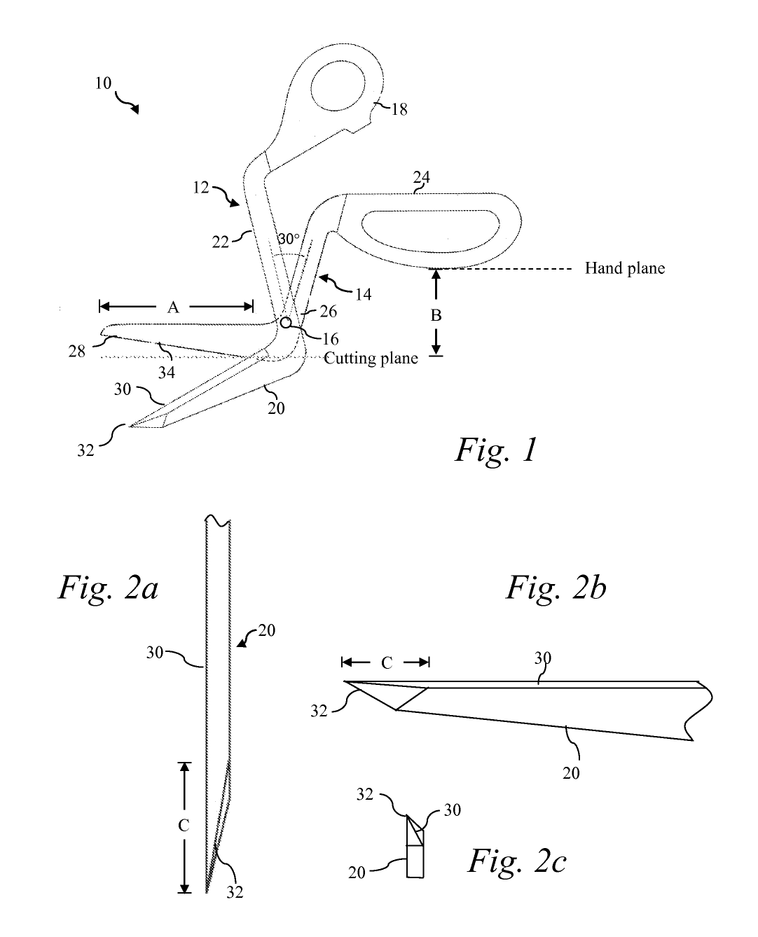

The present invention is best understood in relation to FIGS. 1 through 7a-7c of the drawings, like numerals being used for like elements of the various drawings.

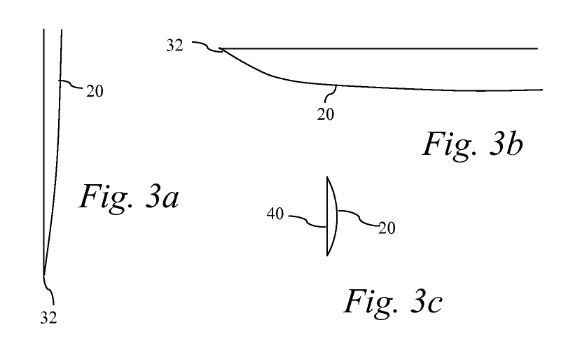

FIG. 1 illustrates a front view of a preferred embodiment of the package cutting scissors (or “shears”) 10 of the present invention. Scissors 10 have two pivoting lever members 12 and 14, rotatably coupled at pivot point 16, which may be implemented with a screw, rivet or similar coupling element. Member 12 includes three portions: handle 18, lower blade 20 and offset portion 22. Member 14 includes handle 24, offset portion 26 and upper blade 28. Lower blade 20 includes a cutting edge 30 and an elongated pointed tip 32 (shown in greater detail in connection with FIGS. 2 and 3). Upper blade 28 also has a cutting edge 34. The offset portion of each member 12 and 14 is approximately at a right angle with the handle and blade portions.

The pivoting members 12 and 14 are preferable formed from steel, such as a carbon stainless steel. The cutting edges 30 and 34 are preferable serrated to grip smooth plastic materials better during cutting. The handles 18 and 24 may be formed from plastic or a cushioned material. Handle 18 interacts with handle 24 such that the pivoting members will not rotate past a blade-closed position. In the preferred embodiment, the scissors 10 are ambidextrous—a single pair can be used in either the right hand or left hand.

The scissors 10 are ideally suited for cutting thermoformed plastic packaging. A first important feature is the pointed tip 32, which is designed to pierce through multiple layers of plastic packaging, such that the cutting can begin at any suitable place in the packaging. A second feature is the offset portions 12 and 14 that distance the user's hand from the packaging, as the packaging is being cut. A third feature is the long cutting blades 20 and 28 which reduce the effort in cutting the packaging.

FIG. 1 provides several dimensions that may be important to the usability of the scissors 10. Dimension A is the cutting length of the scissors with the blades opened at a 30° angle (as shown in FIG. 1). In the preferred embodiment, the cutting length is at least two inches and preferably about 2.5″. Dimension B is the clearance above the cutting plane with the blades opened at a 30° angle. This dimension should be at least 1.5 inches and, in the preferred embodiment, about two inches.

FIGS. 2a through 2c illustrate top, side and front views, respectively of the pointed tip 32. The pointed tip 32 allows the user to pierce the packaging material, even multiple layers of the packaging material, in order to begin a cut within the package (i.e., not starting at the edge of the package). Dimension C shows the length of the point which should be between ½-¾ inches.

In operation, a user can begin a cut, either from an edge of the package, or at an internal point by piercing the packaging material using point 32, such that the lower blade punctures through as many layers of the packaging material as desirable. Thereafter, the scissors are oriented such that the handles are above and generally in parallel to the package. As the user cuts through the package, the offset portions 22 and 26 maintain the user's hands away from the edges exposed by the cut, which can be quite sharp.

FIGS. 3a through 3c illustrate top, side and front views, respectively, of an alternative embodiment of the pointed tip 32. In this embodiment, the lower blade 20 has a knife profile, where it is contoured gradually towards a point, rather than sharp bevel as shown in connection with FIGS. 2a-c. The profile would be similar to a knife or bayonet, but with one flat edge 40 for interacting with the flat side of the upper blade 28 for cutting.

The present invention provides significant advantages over the prior art. First, the hand plane is offset from the cutting plane by a distance to allow the hand plane to be above the packaging throughout the cut. Therefore, the user's hands never contact the packaging material during the cut. Second, the point of one of the blades, typically the lower blade, can pierce through the packaging material to initiate a cut from the interior of the package. Third, the blades provide a long cutting surface to reduce the effort in opening the package.

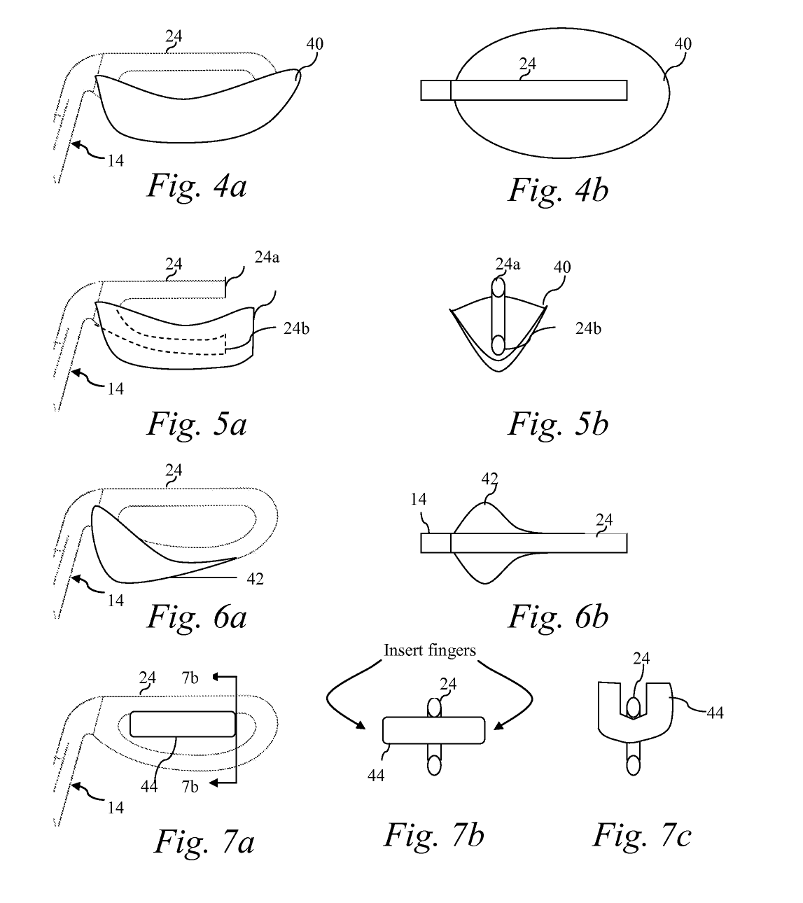

FIGS. 4a-b through FIGS. 7a-c illustrate embodiments for providing a guard member on a lower handle of the scissors in order to protect the user's finger in the event that cut edges of the packaging would otherwise contact the user's hand.

FIGS. 4a and 4b illustrate side and top views, respectively, of a finger shield disposed on the lower handle of the scissors to shield the user's finger's during cutting. The shield 40 extends outwardly and upwardly from the bottom of the handle 24, such that when the user's fingers are gripping the handle 24, the shield 40 protects at least a portion of the user's fingers from contact with cut edges of the packaging. The walls of the shield could extend further up the bottom of the handle, if desired.

The material used for the shield 40 can be rigid or flexible, such as a plastic material. Stronger materials, such as metals, could also be used.

FIGS. 5a and 5b illustrate side and back views of an open ended lower handle portion for facilitating gripping of the lower handle using the shield of FIGS. 4a-b. In this embodiment, the handle includes upper grip 24a and lower grip 24b, with the back of the handle having an open space between the upper and lower grips. Further, the shield 40 in this embodiment has an open back. The purpose of the open back is to provide an easy way to grip the lower handle, especially if the shield is rigid. Using the embodiment shown in FIGS. 5a-b, the user may curl his fingers into a gripping position and slide his hand into the interior of the handle 24, while maintaining curved fingers.

FIGS. 6a and 6b illustrate side and top views, respectively, of a divider disposed on the front of the lower handle of the scissors to divide the cut edges of the packaging material and force the edges downward below the user's fingers during cutting. In this embodiment, the divider will separate and divert any cut packaging edges away from the user's cutting hand as the packaging is being cut.

FIG. 7a illustrates a side view of a handle with a sleeve disposed on the lower handle for encompassing the user's hand during cutting. FIGS. 7b and 7c illustrate back views of the handle of FIG. 7a showing the sleeve in a position to receive the user's fingers and a position to grip the handle, respectively. In this embodiment, a flexible sleeve 44 is provided, into which the user can insert his or her fingers. Once in the sleeve 44, the user can grip the handle normally (see FIG. 7c) with the sleeve providing a protective barrier around the user's fingers. The sleeve can be made of any flexible material, such as a plastic, fibrous, leather, or other material.

The embodiments shown in FIGS. 4a-b through 7a-c provide a significant advantage—even if the packaging has multiple levels that would cause a cut edge to be far enough above the cutting plane to contact the users hand, the user's fingers are protected during cutting.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

I claim:

1. Scissors for cutting through packaging comprising:
first and second lever members;
a coupling member about which the levers may rotate in a first plane;
wherein the lever members each include a cutting portion, a handle portion and an offset portion, said offset portion disposed at an angle between the cutting portion and handle portion and wherein the offset portion keeps the user's hand at least 1.5 inches from a cutting plane in which a cut is made, perpendicular to the first plane and disposed between cutting portions of the lever members, in which a sheet of packaging material to be cut lies; and
wherein a lower handle portion includes a guard member extending outwardly from the handle to protect a user's hands from a cut edge of the packaging as the packaging is being cut.

2. The scissors of claim 1 wherein the guard member comprises a shield positioned at a bottom of the lower handle portion and extending outwardly and upwardly to cover the user's fingers while gripping the lower handle portion.

3. The scissors of claim 1 wherein the guard member comprises a divider positioned at a front of the lower handle portion for separating packaging as the packaging is being cut so that the cut edges of the packaging are diverted away from the user's fingers.

4. The scissors of claim 1 wherein the lower guard member includes a sleeve into which the user's fingers are inserted.

5. The scissors of claim 1 wherein one of the cutting portions of the first and second lever member includes a sharply pointed tip capable of piercing multiple layers of a thermoformed packaging material.

6. The scissors of claim 5 wherein the point is on a lower of the two cutting portions.

7. The scissors of claim 5 wherein the pointed tip is a beveled tip such that the point is defined by the apex of three defined edges of the cutting portion.

8. The scissors of claim 5 wherein the pointed tip is a knife point defined by sides of the cutting portion each tapering to a sharp point.

9. The scissors of claim 1 wherein at least one of the cutting portions includes a serrated edge.

10. The scissors of claim 1 wherein the cutting portions have a cutting edge of at least 2 inches.

11. The scissors of claim 1 wherein the cutting portions have a cutting edge of approximately 2.5 inches.

12. The scissors of claim 1 wherein the offset portion keeps the user's hand approximately two inches from a cutting plane when the offset portions are at an angle of approximately 30 degrees to one another.

13. Scissors for cutting through thermoformed packaging materials, comprising:
first and second lever members;
a coupling member about which the levers may rotate in a first plane;
wherein the lever members each include a cutting portion, a handle portion and an offset portion, said offset portion disposed at an angle between the cutting portion and handle portion and wherein:
the offset portions keep the user's hand at least 1.5 inches from a cutting plane in which a cut is made, perpendicular to the first plane and disposed between the cutting portions of the lever members, in which a sheet of packaging material lies, when the offset portions are at an angle of approximately 30 degrees to one another;
wherein the cutting portions have an edge of at least two inches;
wherein a lower one of the cutting portions includes a sharp pointed tip for piercing multiple layers of a thermoformed packaging material to begin a cut at an interior position of a package; and
wherein a lower handle portion includes a guard member extending outwardly from the handle to protect a user's hands from a cut edge of the packaging as the packaging is being cut.

14. The scissors of claim 13 wherein the pointed tip is a beveled tip such that the point is defined by the apex of three defined edges of the cutting portion.

15. The scissors of claim 13 wherein the pointed tip is a knife point defined by sides of the cutting portion each tapering to a sharp point.

16. Scissors for cutting through packaging comprising:
first and second lever members;
a coupling member about which the levers may rotate in a first plane;
wherein the lever members each include a cutting portion, a handle portion and an offset portion, said offset portion disposed at an angle between the cutting portion and handle portion and wherein the offset portion keeps the user's hand at least 1.5 inches from a cutting plane in which a cut is made, perpendicular to the first plane and disposed between cutting portions of the lever members, in which a sheet of packaging material to be cut lies; and
wherein the offset portion of each lever member is approximately at a right angle with the handle and blade portions.
